(19) United States
(12) Patent Application Publication
(10) Pub. No.: US 2012/0188457 A1
(43) Pub. Date: Jul. 26, 2012

(54) IMAGE PROCESSING APPARATUS AND IMAGE PROCESSING METHOD

(76) Inventor: Takeshi KATO, Kanagawa (JP)

(21) Appl. No.: 13/354,861

(22) Filed: Jan. 20, 2012

(30) Foreign Application Priority Data
Jan. 26, 2011 (JP) P2011-014157

(51) Int. Cl. H04N 5/50

(52) U.S. Cl. 348/569; 348/E05.097

(57) ABSTRACT

An image processing apparatus includes: an operation part that specifies, for an input image of an inputted video signal, a display range of the input image to be displayed on a display part according to a user operation; and an image processing part that extracts an image within the display range from the input image when it is detected that the display range specified by the operation signal reaches an edge of four sides of the input image, and performs a process of drawing a line along an edge of a screen of the display part correspondingly to a direction in which the display range reaches the edge of the four sides of the input image.

### FIELD

The present disclosure relates to an image processing apparatus and an image processing method, and particularly to an on-screen display (OSD) when an image having the number of lines larger than the number of lines of a display panel is displayed on the display panel.

### BACKGROUND

Hitherto, when a pixel zoom display or a native scan display is performed, in order to clarify which portion of an image (hereinafter referred to as an input image) of an inputted video signal is displayed, a frame (cursor) indicating an enlarged range of the input image is displayed on a screen. The pixel zoom display is a display mode in which pixels (resolution) in a part of the input image are enlarged. The native scan display is a display mode in which a pixel in the input image is one-to-one mapped to a pixel in a display device. In the native scan display, also when the enlargement display of an image in a cursor is not performed, for example, also when the number of lines of an effective image range of a video signal is larger than the number of lines of a display device (as an example, a video signal of 2K (2048 pixels×1080 lines) is displayed at a pixel equal magnification on a display panel of 1920 pixels×1080 lines), the display of the cursor is convenient.

The function to display the frame indicating the enlarged range of the input image on the screen as stated above or to display a setting screen is generally called “on-screen display”. Besides, displaying the setting screen or the like on the screen by the on-screen display is called “OSD display”. Hereinafter, the related art will be described in more detail. Incidentally, in the following description, for convenience of description, pixels arranged in a vertical direction of an input image, that is, pixels in one column are sometimes called one line.

FIG. 11 is an explanatory view showing a structural example of a general image display system for performing the OSD display.

The image display system includes a controller 101 and a display device 102, and they are connected to each other through a signal cable. The controller 101 is provided with operation means, such as a button or a rotary encoder, for controlling an image to be displayed on a screen of the display device 102. As the display device 102, for example, a liquid crystal display device is used.

The controller 101 is provided with a function button to perform pixel zoom. When the user depresses the function button, a square cursor 104 as shown in FIG. 12 is displayed in a state where an image (input image) corresponding to a video signal inputted to the display device 102 is displayed on the whole of a screen 103. When the pixel zoom is desired to be performed, the user operates the rotary encoder of the controller 101 to move the cursor 104 up and down and left and right, and specifies a place where the image is desired to be enlarged. By this, as shown in FIG. 13, an image (enlarged image 105) obtained by enlarging the specified place of the image is displayed on the screen 103. In general, when the cursor 104 is moved and the place desired to be enlarged is specified in an enlargement range specification mode or the like, the specified place is enlarged in according with the aspect ratio of the screen of the display device 102. After the specified place of the input image is enlarged and is displayed on the screen 103, the content of the enlarged image 105 can be changed by operating the rotary encoder to move the enlarged place of the input image up and down and left and right.

In general, when a video signal having the number of lines larger than the number of lines of a display device is displayed on the display device, a scaling process (enlarging process) is performed so that the image of the video signal falls within the number of lines of the display device. For example, when a video signal of 2048×1080 is displayed on a screen of a display device which can display only 1920×1080; areas in which the right and left of the image corresponding to the video signal protrude from the screen are made to fall within the screen by the scaling process and are displayed. Thus, as shown in FIG. 14, non-display areas 110a and 110b are generated in the upper and lower parts of a screen 110 on which an image 111 after the scaling process is displayed.

When the video signal in FIG. 14 is displayed in the native scan mode, since the number of lines in the vertical direction is equal to the number of lines of the screen 110, as shown in FIG. 15, protrusion occurs at the right and left of the displaceable area of the screen 110. Areas 112a and 112b represent portions of the image corresponding to the video signal, which can not be displayed on the screen 110 and protrude. When the whole image is confirmed, the image is moved right and left by the rotary encoder, and the position is adjusted.

In the case of the method using the cursor as stated above, after the enlarged image is displayed, the cursor is not displayed. Thus, when the image comes not to move, it is first understood that the cursor collides with an edge (image edge) of the input image. Besides, there is a case where as the operation proceeds, it becomes uncertain that the cursor reaches which edge among the up, down, right and left edges of the image. Although an operating user can understand, a user viewing only the screen can not understand from only the image displayed on the screen that the cursor reaches which edge.

In order to solve the foregoing problem, OSD display as described below is generally performed.

FIG. 16 shows a first example of the OSD display of the related art. In FIG. 16, a dedicated user interface area (UI area 114) to display an enlarged position and the standard of a size is secured in a part of a screen 110. It is understood from a cursor 113 in the UI area 114 that which part of an image is enlarged. The side of an enlarged image 113A displayed on the screen 110 is adjusted so that the image does not overlap with the UI area 114.

FIG. 17 shows a second example of the OSD display of the related art. In FIG. 17, a UI area 114 is provided to be superimposed on an enlarged image 113B which is displayed on the whole screen. As an example, JP-A-2004-23632 (patent document 1) discloses a digital camera in which an enlargement frame indicating the size and position of a digital zoom area is displayed on a monitor at the time of photographing. By this, a photographer can visually determine a zoom magnification to an image of the whole pixel area captured by an imaging device, and can easily determine the zoom center position.

### SUMMARY

In the example shown in FIG. 16, since the display area of the enlarged image is reduced, and the UI area 114 as the standard of the enlarged range of the image corresponding to the video signal is displayed, the display range of the enlarged image is significantly reduced. Thus, the whole screen can not be effectively used, and the visibility is not good.

In the example shown in FIG. 17, in order to avoid the problem of the example of FIG. 16, the UI area 114 is superimposed on the enlarged image 113B and is displayed. However, the user can not visually recognize a portion of the enlarged image 113B, which overlaps with the UI area 114. Especially, in a video editing operation, it is desirable that the entire of the enlarged image can be visually recognized to the utmost.

Thus, it is desirable to secure an effective display area of a display device to the utmost and to make it possible to easily recognize that an edge of a specified display range reaches an edge of an input image.

According to an embodiment of the present disclosure, an operation part provided in an image processing apparatus generates an operation signal to specify, for an input image of an inputted video signal, a display range of the input image to be displayed on a display part according to a user operation. When an image processing part provided in the image processing apparatus detects that the display range specified by the operation signal reaches an edge of four sides of the input image, the image processing part extracts an image within the display range from the input image, and performs a process of drawing a line along an edge of a screen of the display part is performed correspondingly to a direction in which the display range reaches the edge of the four sides of the input image.

According to the embodiment of the present disclosure, an image processing part detects that a display range specified by a user operation reaches an edge of four sides of an input image. An image within the display range is extracted from the input image, and a line is drawn along an edge of a screen of a display part correspondingly to a direction in which the display range reaches the edge of the four sides.

According to the embodiment of the present disclosure, the effective display area of the display device is secured to the utmost, and even a non-operating user can easily recognize that the edge of the specified display range reaches the edge of the input image.

### BRIEF DESCRIPTION OF THE DRAWINGS

FIGS. 1A to 1D are explanatory views showing the outline of a first example (pixel zoom) of an image edge display in an embodiment of the present disclosure.

FIGS. 2A and 2B are explanatory views showing the outline of a second example (native scan) of the image edge display in the embodiment of the present disclosure.

FIG. 3 is a block diagram showing an internal structure of a display device in the embodiment of the present disclosure.

FIG. 4 is a sequence view of an image edge display process in the embodiment of the present disclosure.

FIG. 5 is an explanatory view of parameters for displaying a line at an edge of a screen in the embodiment of the present disclosure.

FIG. 6 is an explanatory view showing a state where a left edge of an enlarged range collides with a left edge of the screen.

FIG. 7 is an explanatory view showing a state where a bottom edge of an enlarged range collides with a bottom edge of the screen.

FIG. 8 is an explanatory view showing a screen on which a line is displayed at the left edge and the bottom edge of a screen in the embodiment of the present disclosure.

FIG. 9 is an explanatory view showing a modified example of an image edge display in the embodiment of the present disclosure.

FIG. 10 is a block diagram showing a modified example of an internal structure of a display device in the embodiment of the present disclosure.

FIG. 11 is an explanatory view showing a structural example of a general image display system for performing an OSD display.

FIG. 12 is an explanatory view of the OSD display.

FIG. 13 is an explanatory view of an enlarged display of pixels (resolution) of an input image by pixel zoom.

FIG. 14 is an explanatory view showing an example in which a video signal having the number of lines larger than the number of lines of a display device is displayed on the display device.

FIG. 15 is an explanatory view showing an example of native scan display.

FIG. 16 is an explanatory view showing a first example (dedicated user interface area is displayed on a part of a screen) of related art OSD display.

FIG. 17 is an explanatory view showing a second example (dedicated user interface area is superimposed on an enlarged image) of related art OSD display.

### DETAILED DESCRIPTION

Hereinafter, embodiments of the present disclosure will be described with reference to the attached drawings. Incidentally, the same component in the respective drawings is denoted by the same reference numeral and its duplicate explanation is omitted.

### OUTLINE OF THE PRESENT DISCLOSURE

### Display Mode in the Case of Pixel Zoom Display

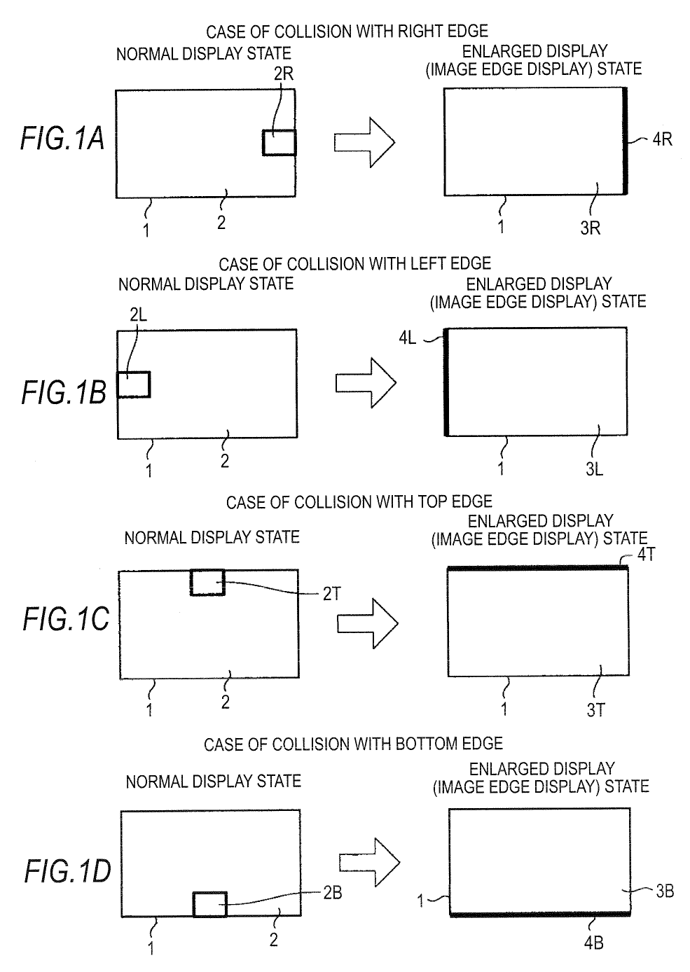

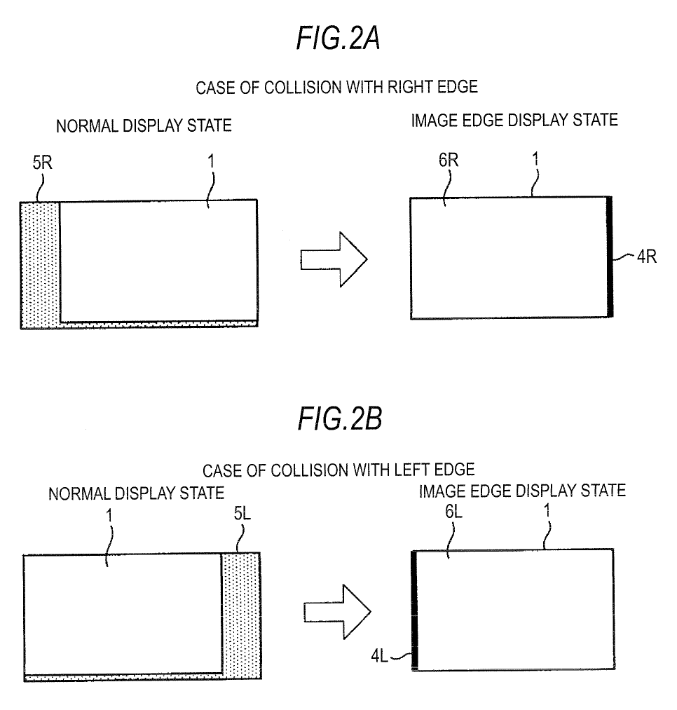

Hereinafter, functions of an image processing apparatus of an embodiment of the present disclosure will be described with reference to FIG. 1A to FIG. 2B. The present disclosure can be applied to an input image of m pixels×n lines (m and n are arbitrary natural numbers).

First, as a first example of the embodiment of the present disclosure, the case of pixel zoom display will be described.

FIGS. 1A to 1D are explanatory view showing an example in which an edge (image edge) of an input image is displayed in the case of the pixel zoom display. The left side of each of FIG. 1A to FIG. 1D shows a states in which a display range desired to be enlarged is shown in the input image, and the right side shows a state in which an image within the display range is enlarged and displayed.

In the case of the pixel zoom display, when a frame (display range frame) showing a display range of an input image reaches an edge of four sides of the input image, a line is drawn at an edge of a screen displaying an enlarged image correspondingly to a direction in which the display range frame reaches the edge of the four sides of the input image. Here, the input image represents an image of a video signal inputted to the image processing apparatus. Besides, in the following description, the line indicating that the display range frame reaches the edge of the four sides of the input image is called “edge line”.

For example, as shown in FIG. 1A, it is assumed that in a normal display state (for example, a state in which an input image 2 is displayed on the whole of a screen 1 which is an effective display area of a display device), a display range frame 2R collides with the right edge of the input image 2. In this case, an edge line 4R is displayed at the right edge of the screen 1 displaying an enlarged image 3R obtained by enlarging the display range of the input image 2. Hereinafter, in this embodiment, the OSD display includes displaying the edge line.

Besides, as shown in FIG. 1B, in the normal display state, when a display range frame 2L collides with the left edge of the input image 2, an edge line 4L is displayed at the left edge of the screen 1 displaying an enlarged image 3L obtained by enlarging the display area of the input image 2.

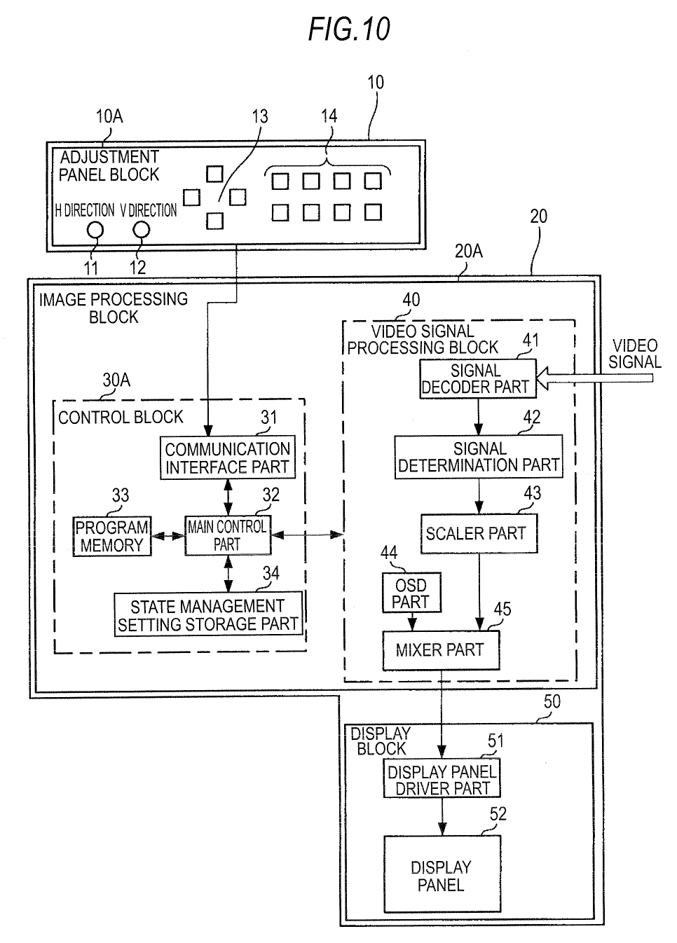

Besides, as shown in FIG. 10, in the normal state, when a display range frame 2T collides with the top edge of the input image 2, an edge line 4T is displayed at the top edge of the screen 1 displaying an enlarged image 3T obtained by enlarging the display area of the input image 2.

Besides, as shown in FIG. 1D, in the normal display state, when a display range frame 2B collides with the bottom edge of the input image 2, an edge line 4B is displayed at the bottom edge of the screen 1 displaying an enlarged image 3B obtained by enlarging the display area of the input image 2.

### (Display Mode in the Case of Native Scan Display)

Next, as a second example of the embodiment of the present disclosure, the case of native scan display will be described.

FIGS. 2A and 2B are explanatory views showing an example of image edge display in the case of the native scan display. The left side of each of FIGS. 2A and 2B shows an image obtained by enlarging an input image at a pixel equal magnification to a display device, and the right side shows a state in which an edge line is displayed. Incidentally, in FIGS. 2A and 2B, in order to facilitate understanding that the number of lines in the horizontal direction of an input image 5R (5L) is larger than the size of a screen 1, a part of the input image is displayed so as to protrude from the lower part of the screen 1.

In the case of the native scan display, when a display range of the input image reaches an edge of four sides of the input image, a line is drawn at an edge of the screen displaying a display image correspondingly to a direction in which the display range reaches the edge of the four sides.

For example, as shown in FIG. 2A, in a normal display state (for example, a state in which an input image 5R is displayed at a pixel equal magnification on the screen 1 of the display device), it is assumed that the display range collides with the right edge of the input image 5R. In this case, an edge line 4R is displayed at the right edge of the screen 1 displaying an image 6R within the display range of the input image 5R.

Besides, as shown in FIG. 2B, in the normal display state, when the display range collides with the left edge of an input image 5L, an edge line 4R is displayed at the left edge of the screen 1 displaying an image 6L within the display range of the input image 5L.

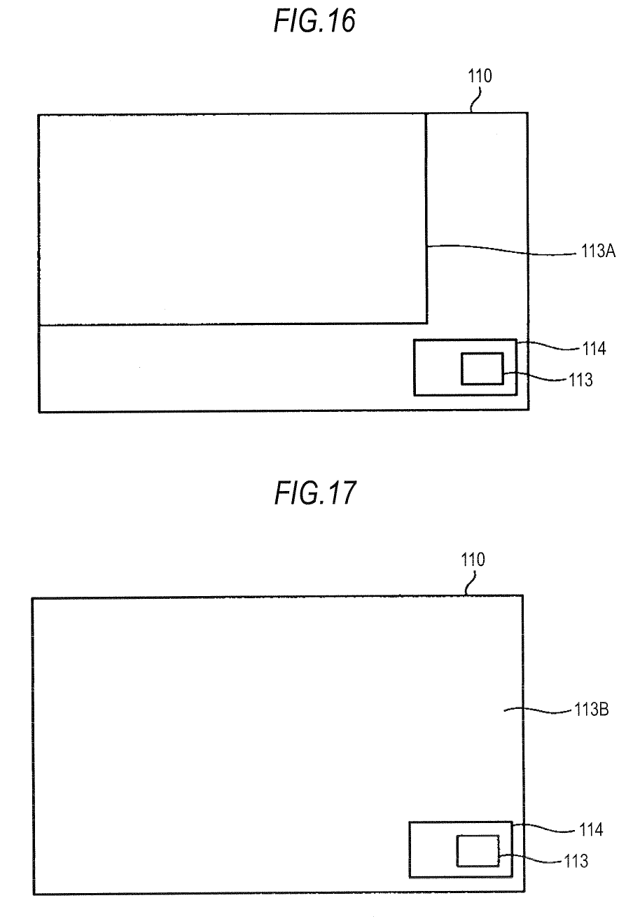

As described above, when the display range frame indicating the enlarged image (pixel zoom display) or the display image (native scan display) is moved, when the edge of the display range reaches the edge of the four sides of the input image, the line (edge line) is displayed along the edge on the screen edge side in the reach direction. By that, the display area of the screen (display device) can be used as effectively as possible. Besides, without providing the dedicated user interface area (see FIG. 16 and FIG. 17), the user can be made to visually recognize that the enlarged image or the display image reaches the edge of the input image.

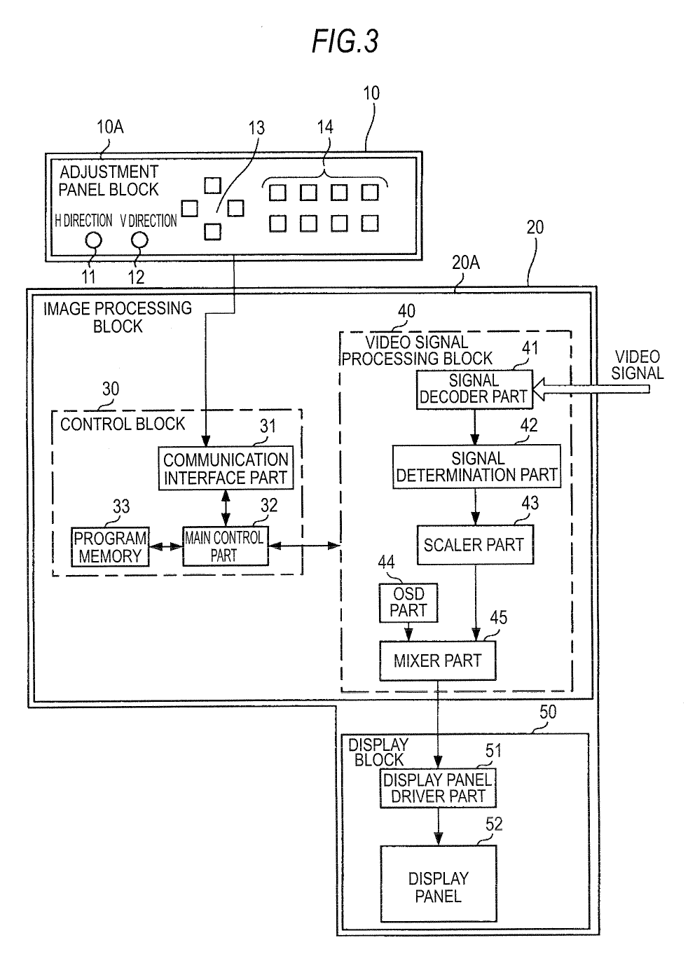

Incidentally, with respect to the edge line shown in FIGS. 1A to 1D and FIGS. 2A and 2B, the user can specify an arbitrary color, rightness and thickness by using an after-mentioned adjustment panel block 10A (see FIG. 3). Besides, in the example of the native scan display of FIGS. 2A and 2B, the description is made on the case where the display area is moved right or left from the normal display state (for example, the state where the input image 5R is displayed at the pixel equal magnification on the screen 1 of the display device). However, the embodiment can be applied to a case where the display range is enlarged and displayed. Besides, although it is desirable that the shape of the display range frame is rectangular and the aspect ratio (horizontal to vertical ratio) thereof is equal to the aspect ratio of the screen 1, no limitation is made to that.

### <Structure of the Image Processing Apparatus>

Hereinafter, a structural example of the image processing apparatus of the embodiment of the present disclosure will be described with reference to FIG. 3.

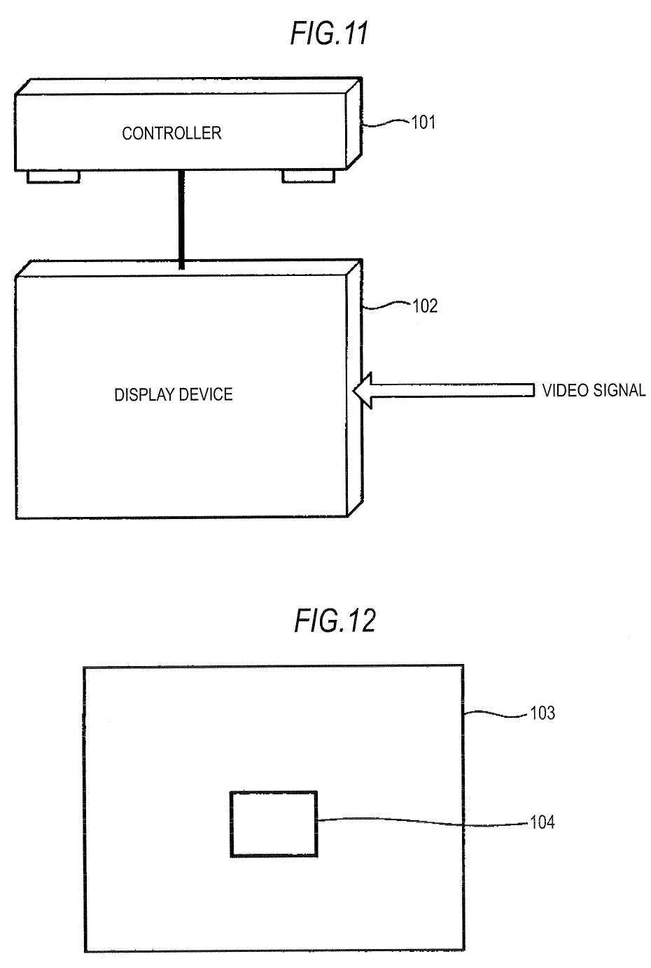

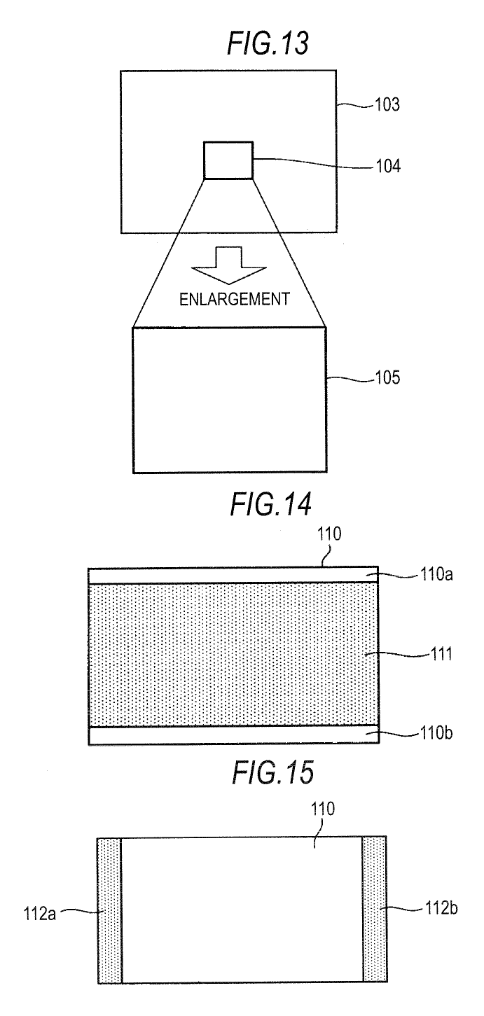

FIG. 3 is a block diagram showing an internal structure of a display device to which the image processing apparatus of the embodiment of the present disclosure is applied. A display device 20 corresponds to the display device 102 of FIG. 11.

As shown in FIG. 3, the display device 20 includes an image processing block 20A and a display block 50. The image processing block 20A is connected to an adjustment panel block 10A of a controller 10 so as to be capable of transmitting and receiving various data and control signals. Besides, the image processing block 20A is connected to the display block 50 so as to be capable of transmitting image data (video signal).

The adjustment panel block 10A is an example of an operation part, and is a block to generate an operation signal corresponding to a user operation and to output the operation signal to a control block 30 of the image processing block 20A. In this example, the adjustment panel block includes rotary encoders 11 and 12, a cursor key 13 and several buttons 14. The rotary encoders 11 and 12 are respectively rotary type operators to move a display range (display range frame) in an H direction (horizontal direction) and a V direction (vertical direction). Besides, the cursor key 13 is operated to set a zoom magnification and the like. The buttons 14 include a button to select a pixel zoom display mode or a native scan display mode, and a decision button. The adjustment of the contrast, brightness and the like of the display device 20 and the user interface for using various functions of the display device 20 are realized based on the operation signal outputted by the adjustment panel block 10A. The adjustment panel block 10A may be a separation type in which it is externally attached to the display device 20 as in this embodiment, or may be an integral type in which it is incorporated in the display device 20.

The image processing block 20A is an example of an image processing part, and includes the control block 30 and a video signal processing block 40. The control block 30 is an example of a control part, and is a block to control the whole display device 20. In this example, the control block includes a communication interface part 31, a main control part 32 and a program memory 33.

The communication interface part 31 receives the operation signal outputted from the adjustment panel block 10A, converts the operation signal into a signal of a format which can be analyzed by the main control part 32, and outputs the signal to the main control part 32.

The main control part 32 reads a computer program stored in the program memory 33 of a nonvolatile memory into a not-shown RAM (Random Access Memory), and performs a specified process in accordance with the computer program. For example, the main control part acquires the operation signal outputted from the adjustment panel block 10A, and gives an instruction to each block in the video signal processing block 40 according to the content of the operation signal, performs an arithmetic processing relating to image display; or stores various setting information. As the main control part 32, an arithmetic processing unit such as a CPU (Central Processing Unit) is used.

The video signal processing block 40 is an example of a video signal processing part, and performs a specified process on an inputted video signal in accordance with the instruction from the control block 30. The video signal processing block 40 includes a signal decoder part 41, a signal determination part 42, a scaler part 43, an OSD part 44 and a mixer part 45.

The signal decoder part 41 converts video signals of various standards into internal signals to be processed in the video signal processing block 40. The signal decoder part 41 may be incorporated in the display device 20 so as to be capable of handling various video signals as in this example, or may be provided as an external operation board so as to be capable of handling various video signals. As the video signals, for example, there are standards such as DVI (Digital Visual Interface), HDMI (High Definition Multimedia Interface), Display Port and HD-SDI (High Definition-Serial Digital Interface).

The signal determination part 42 is for determining the number of lines of the video signal outputted by the signal decoder part 41 in the H direction (corresponding to the horizontal direction) and the V direction (corresponding to the vertical direction). In general, in the video signal inputted from the outside, since the number of lines is not constant in both the H direction and the V direction, the signal determination part 42 of the video signal processing block 40 automatically determines the number of lines, and notifies the main control part 32 of the number of lines. By doing so, the input image or a part thereof is enlarged or contracted and is displayed on a display panel 52 of the display block 50.

The scaler part 43 performs a so-called scaling process in which a pixel (resolution) of a signal obtained by converting the video signal inputted from the outside into an internally used one by the signal decoder part 41 is enlarged or contracted to a target pixel (resolution) by using linear interpolation or the like. In the scaler part 43, the number of vertical and horizontal lines of the input image is converted into the number of lines of the display area (for example, the whole screen) of the display panel 52 of the display block 50, or the number of vertical and horizontal lines of an image within a specified display range of the input image is converted into the number of lines of the display area of the display panel 52.

The OSD part 44 is for displaying the on screen display, and generates a signal (OSD signal) for performing arbitrary text or image drawing by the main control part 32 in order to perform various operation settings. As stated above, the video signal processing block 40 has not only a function to output the inputted video signal to the display block 50 as it is, but also a function to perform the OSD display by superposition on the input image or the image within the specified display range of the input image.

The mixer part 45 superimposes the signal outputted from the scaler part 43 and the signal outputted from the OSD part 44, and outputs them to the display block 50.

The display block 50 is an example of a display part, and includes a display panel driver part 51 and the display panel 52. The display panel driver part 51 is an electronic circuit for displaying a video signal desired to be finally displayed on the display panel 52, supplies drive signals based on the video signal to the lines in the H direction and the V direction of the display panel 52, and controls driving of the display panel 52. The display panel 52 is a device that converts the inputted video signal (electric signal) into colors and displays the signal as an image. As the display panel 52, for example, a liquid crystal panel or an organic EL panel is used.

### <Process of the Image Processing Apparatus>

Next, a description will be made on a display process of an image edge by the display device 20 to which the image processing apparatus of the embodiment of the present disclosure is applied.

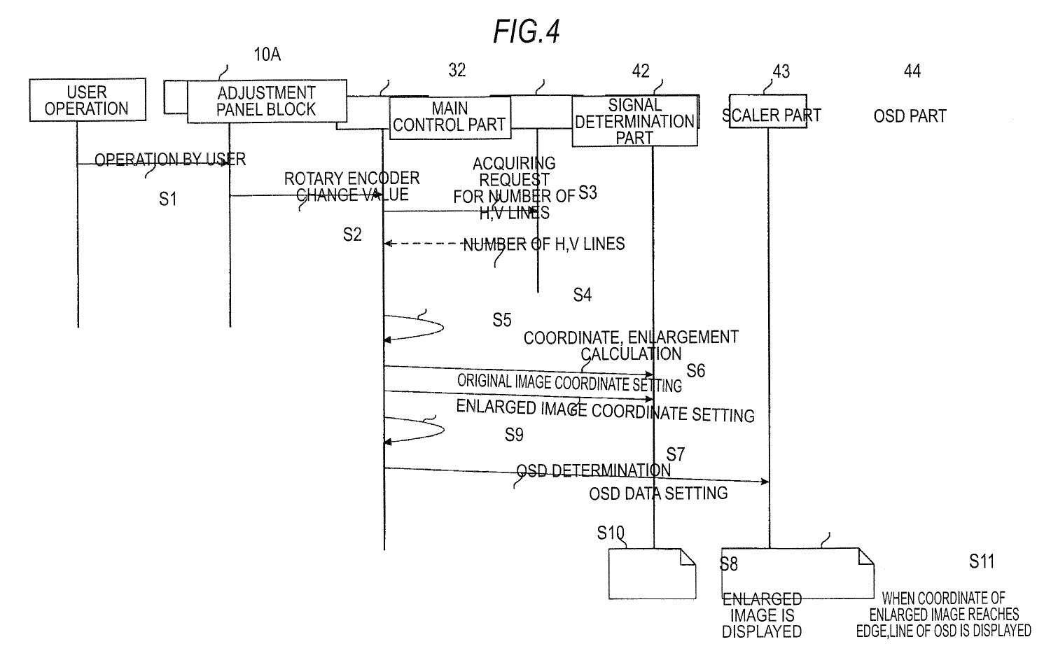

FIG. 4 is a sequence view showing the display process of the image edge by the display device 20. In the pixel zoom display state or the native scan display state, the basic setting procedure in the display device 20 when the position of a range desired to be enlarged or displayed, that is, the display range frame is changed is as described below.

First, the user operates the rotary encoder 11, 12 of the adjustment panel block 10A (step S1). In the adjustment panel block 10A, the operation signal corresponding to the change value of the rotary encoder 11, 12 is outputted to the main control part 32 through the communication interface part 31 (step S2).

The main control part 32 receiving the operation signal requests the signal determination part 42 to acquire the number of lines in the H direction and the V direction of the video signal inputted to the signal decoder part 41 (step S3), and acquires the number of lines in the H direction and the V direction of the video signal from the signal determination part 42 (step S4). Then, the main control part 32 calculates, based on the operation signal, the coordinate (position of the display range frame) of the specified display range of the input image and an enlargement ratio for displaying the image within the display range on the screen of the display panel 52 (step S5).

Thereafter, the main control part 32 sets the coordinate of the input image (original image), and notifies the scaler part 43 (step S6). Besides, the main control part 32 sets the coordinate of the image (enlarged image) within the display range of the input image, and notifies the scaler part 43 (step S7). The scaler part 43 performs a scaling process based on the coordinates of the original image and the enlarged image notified from the main control part 32, and outputs the video signal after the scaling process to the mixer part 45. The mixer part 45 outputs the video signal after the scaling process to the display panel driver part 51. The display panel driver part 51 drives the display panel 52, and causes the display panel 52 to display the image obtained by enlarging the specified display range of the input image (step S8).

On the other hand, the main control part 32 performs an OSD determination (step S9). That is, the main control part determines whether the frame (display range frame) indicating the display range of the input image reaches an edge of the four sides of the input image, and when the frame reaches the edge, the main control part determines whether the display range frame reaches which edge of the four sides of the input image. Then, based on the determined result, the main control part sets OSD data from which the OSD part 44 generates the OSD signal, and notifies the OSD part 44 (step S10).

The OSD part 44 generates the OSD signal based on the set value of the OSD data notified from the main control part 32. The generated OSD signal is superimposed on the video signal from the scaler part 43 by the mixer part 45, and is outputted to the display driver part 51. By that, when the edge of the enlarged image, that is, the edge of the display range of the input image reaches the edge of the four sides of the input image, the line (edge line) is displayed at the edge of the screen of the display panel 52 in the relevant direction (step S11) (see FIG. 1A to FIG. 2B).

### <Determination Method of Image Edge Display>

A normal function of the display device 20 is to display the whole inputted video signal on the display panel 52, and the function of pixel zoom display and native display is a well-known function. That is, in addition to the existing function of pixel zoom display and native display, displaying the line (edge line) indicating the image edge at the edge of the screen is novel. Hereinafter, a condition under which the image edge is displayed on the screen will be described.

### (Case of Pixel Zoom Display)

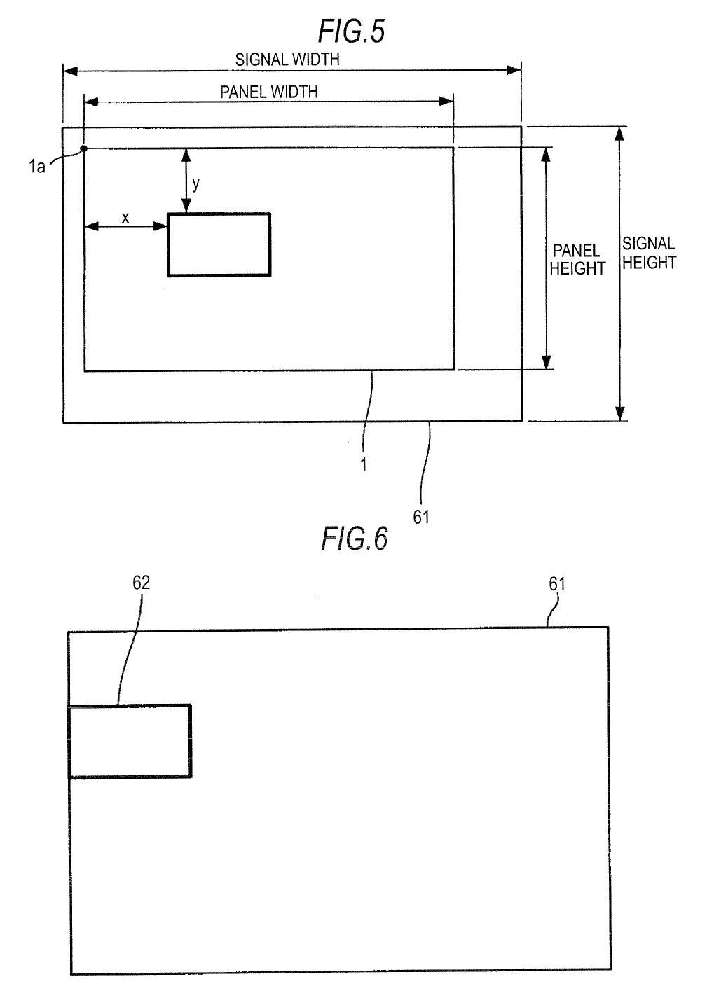

FIG. 5 is an explanatory view of parameters for displaying an edge line at an edge of a screen. A screen 1 represents the size of the display panel 52 in pixel units, and an input image 61 represents the size of an input video signal in pixel units. First, parameters (variables) for determining an image edge display algorism as shown in Table 1 are previously defined.

TABLE 1

| Explanation of Parameter | Variable Name |
|---|---|
| enlargement magnification | n |
| number of lines in horizontal direction of | PanelWidth |
| display device | |
| number of lines in vertical direction of | PanelHeight |
| display device | |
| number of lines in horizontal direction of | SignalWidth |
| input signal | |
| number of lines in vertical direction of | SignalHeight |
| input signal | |
| vertical direction coordinate of | x |
| pre-enlargement range from upper left | |
| horizontal direction coordinate of | y |
| pre-enlargement range from upper left | |

The enlargement magnification (n) is determined from pixels (resolution) of an image within a display range frame 62 and pixels (resolution) after enlargement. The information of the number of lines (PanelWidth, PanelHeight) in the horizontal direction and the vertical direction of the display panel 52 (screen 1) is acquired by, for example, the main control part 32 from the display block 50 through the video signal processing block 40, and is stored in an internal register or the program memory 33 and the like. The number of lines (SignalWidth, SignalHeight) in the horizontal direction and the vertical direction of the input video signal (input image 61) is obtained by the signal decoder part 41. The coordinate of the pre-enlargement range (display range) from the upper left (original point 1a) of the input image in the horizontal direction is x, and the coordinate of the pre-enlargement range (display range) from the upper left of the input image in the vertical direction is y.

In order to realize the pixel zoom by using the whole surface of the display panel 52, the number of lines in the horizontal direction of the image within the display range is determined by PanelWidth/n, and the number of lines in the vertical direction is determined by PanelHeight/n. The main control part 32 gives an instruction of the display range of the input image to the scaler part 43 by using one of PanelWidth/n and PanelHeight/n. Besides, with respect to the line of the image edge, the main control part gives an instruction of display setting to the OSD part 44 through a determination described below.

(Determination Method when the Right Edge or the Left Edge of the Input Image is Displayed on the Screen)

When the left edge or the right edge of the input image 61 is displayed, it is necessary that the size in the horizontal direction of the input image 61 is larger than the size in the horizontal direction of the image within the specified display range (display range frame 62) (PanelWidth/n<SignalWidth) (see FIG. 5). The condition under which the right edge or the left edge of the input image is displayed is as described below.

### (1) Condition for Displaying the Left Edge of the Input Image

The rotary encoder 11 is operated to move the display range of the input image, and x=0 is established (see FIG. 6).

### (2) Condition for Displaying the Right Edge of the Input Image

The rotary encoder 11 is operated to move the display range of the input image, and {x+(PanelWidth/n)}=SignalWidth is established.

(Determination Method when the Top Edge or the Bottom Edge of The Input Image is Displayed on the Screen)

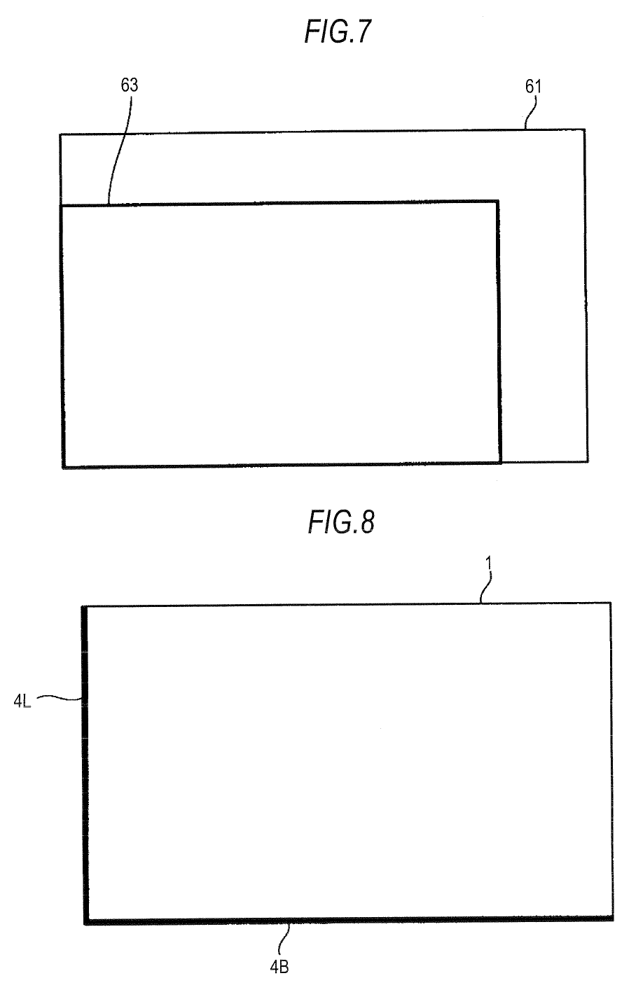

When the top edge or the bottom edge of the input image 61 is displayed, it is necessary that the size in the vertical direction of the input image 61 is larger than the size in the vertical direction of the image within the specified display range (display range frame 63) (PanelHeight/n<SignalHeight) (see FIG. 7). The condition under which the top edge or the bottom edge of the input image is displayed is as described below.

### (1) Condition for Displaying the Top Edge of the Input Image

The rotary encoder 12 is operated to move the display range of the input image, and y=0 is established.

### (2) Condition for Displaying the Bottom Edge of the Input Image

The rotary encoder 12 is operated to move the display range of the input image, and {y+(PanelHeight/n)}=SignalHeight is established (see FIG. 7).

As shown in FIG. 7, when the left edge and the bottom edge of the display range frame 63 of the input image 61 reach the left edge and the bottom edge of the input image 61, lines (edge lines) are displayed at the left edge and the bottom edge of the screen 1. FIG. 8 shows an example in which edge lines 4L and 4B are displayed at the left edge and the bottom edge of the screen.

### (Case of Native Scan Display)

Similarly to the case of the pixel zoom display, also in the case of the native scan display, first, parameters for determining an image edge display algorism as shown in Table 2 are previously defined.

TABLE 2

| Explanation of Parameter | Variable Name |
|---|---|
| enlargement magnification in horizontal | N_Width |
| direction | |
| enlargement magnification in vertical | N_Height |
| direction | |
| number of lines in horizontal direction of | PanelWidth |
| display device | |
| number of lines in vertical direction of | PanelHeight |
| display device | |
| number of lines in horizontal direction of | SignalWidth |
| input signal | |
| number of lines in vertical direction of | SignalHeight |
| input signal | |
| vertical direction coordinate of | x |
| pre-enlargement range from upper left | |
| horizontal direction coordinate of | y |
| pre-enlargement range from upper left | |

In the native scan display, differently from the pixel zoom display, since the magnification in the vertical direction and the magnification in the horizontal direction are not necessarily equal to each other, the enlargement magnification n_Width in the horizontal direction and the enlargement magnification n_Height in the vertical direction are set. The basic way of thinking of the other parameters is the same as the pixel zoom display. Incidentally, in the case of simple native scan display (pixel equal magnification display) without enlargement, the enlargement magnification n_Width or n_Height is 1.

(Determination Method when the Right Edge or the Left Edge of the Input Image is Displayed on the Screen)

When the left edge or the right edge of the input image 61 is displayed, it is necessary that the size in the horizontal direction of the input image 61 is larger than the size in the horizontal direction of the image within the specified display range (display range frame 62) (PanelWidth/n_Width<SignalWidth) (see FIG. 5). The condition under which the right edge or the left edge of the input image is displayed is as described below.

### (1) Condition for Displaying the Left Edge of the Input Image

The rotary encoder 11 is operated to move the display range of the input image, and x=0 is established (see FIG. 6).

### (2) Condition for Displaying the Right Edge of the Input Image

The rotary encoder 11 is operated to move the display range of the input image, and {x+(PanelWidth/n_Width)=SignalWidth} is established.

(Determination Method when the Top Edge or the Bottom Edge of the Input Image is Displayed on the Screen)

When the top edge or the bottom edge of the input image 61 is displayed, it is necessary that the size in the vertical direction of the input image 61 is larger than the size in the vertical direction of the image within the specified display range (display range frame 63) (PanelHeight/n_Height<SignalHeight) (see FIG. 7). The condition under which the top edge or the bottom edge of the input image is displayed is as described below.

### (1) Condition for Displaying the Top Edge of the Input Image

The rotary encoder 12 is operated to move the display range of the input image, and y=0 is established.

### (2) Condition for Displaying the Bottom Edge of the Input Image

The rotary encoder 12 is operated to move the display range of the input image, and {y+(PanelHeight/n_Height)=SignalHeight} is established (see FIG. 7).

### <Variation of the Image Edge Display>

A variation of a display method of an edge line indicating that an image within a specified display range reaches an edge of four sides of an input image will be exemplified. As an example, the following three display methods are conceivable.

(1) When the image within the display range reaches an edge of the four sides of the input image, the edge line is always displayed.
(2) Only when the image within the display range reaches an edge of the four sides of the input image, the edge line is displayed (and then, disappears).
(3) When the image within the display range reaches an edge of the four sides of the input image, the edge line is blinked and displayed.

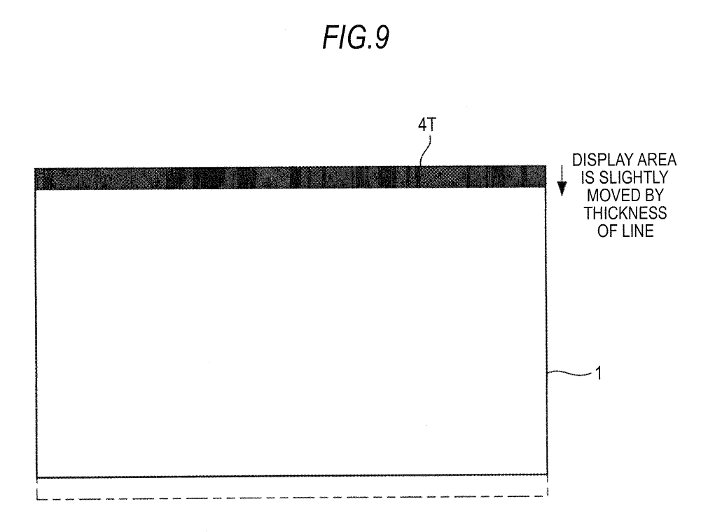

In the case of the above (1), the OSD part 44 generates a signal (OSD signal) for drawing the line along the edge part at the edge the screen correspondingly to the direction in which the display range reaches the edge of the four sides of the input image. At the same time, it is desirable that the scaler part 43 generates an output video signal which shifts the extracted image by the thickness of the line drawn along the edge part of the screen and displays the image on the screen. That is, in order to prevent the edge line indicating the image edge from overlapping with the image obtained by enlarging the display range, when the display range collides with the edge of the input image, the display position of the enlarged image to be displayed on the display panel 52 is shifted by the thickness of the displayed edge line. In the example of FIG. 9, since the display position of the enlarged image is shifted downward by the thickness of an edge line 4T at the top edge of the screen, a bottom edge portion (two-dot chain line portion) of the enlarged image is not displayed.

In the case of the above (2), when the display range reaches an edge of the four sides of the input image, the OSD part 44 generates a signal (OSD signal) for drawing a line along the edge part of the screen correspondingly to the direction in which the display range reaches the edge of the four sides of the input image during the continuation of the user operation. For example, setting may be made such that after the user operation is stopped, the display of the image edge disappears when a specific time elapses.

Besides, in the case of the above (3), when the display range reaches an edge of the four sides of the input image, the OSD part 44 generates a signal (OSD signal) for drawing a line blinking at regular time intervals along the edge part of the screen correspondingly to the direction in which the display range reaches the edge of the four sides.

Table 3 shows the results of comparison of the above display methods (1) to (3). The evaluation of each item becomes high in order of A, B and C. A′ indicates evaluation between A and B.

TABLE 3

| | | Person other than operator |
|---|---|---|
| | | can easily recognize that |
| Display | The whole area of panel is | enlarged image reaches |
| method | used in enlarged display | image edge |
| 1 | A | C |
| 2 | A′ | B |
| 3 | B | A |

In the case of the above (2) and (3), the whole area of the screen of the display panel is used for the display of the image within the specified display range. However, in the case of (2), since the image edge is displayed only when the image within the display range reaches the edge of the four sides of the input image (during the continuation of the user operation), it is hard for the person other than the operating user to recognize that the image within the specified display range reaches the image edge of the input image. In the case of (3), since the image edge is blinked and displayed, the image overlapping with the image edge can be visually recognized according to the timing of blinking. On the other hand, in the case of (1), although the display area of the screen 1 is slightly sacrificed, there is a merit that the sacrificed display area is certainly narrower than the related art method in which the UI area is provided to indicate the enlargement display position (see FIG. 16 and FIG. 17).

### <Modified Example of the Structure of the Image Processing Apparatus>

A modified example of the structure of the image processing apparatus of the embodiment will be described.

FIG. 10 is a block diagram showing a modified example of an internal structure of a display device to which the image processing apparatus of the embodiment of the present disclosure is applied. A display device 20 shown in FIG. 10 is different from the structure of the display device 20 shown in FIG. 3 in that a state management setting storage part 34 is provided. An image processing block 20A of the display device 20 includes a control block 30A provided with the state management storage part 34 and a video signal processing block 40.

The state management setting storage part 34 is a nonvolatile memory such as a flash memory, and is used to manage and set the state of the display device 20. Information for managing and setting the state of the display device 20 is stored in the state management setting storage part 34, so that at the time of next image edge display, the state of the display device 20 at the time of the last image edge display is read, and the image edge display similar to the last time can be performed. Besides, when the setting information of the three variations of the image edge display is stored in the state management setting storage part 34, the variation of the image edge display can be easily changed by operating the adjustment panel block 10A.

Further, in the embodiment of the present disclosure, the edge line displayed at the edge of the screen may be semitransparent. In this case, since the image (background) of the portion overlapping with the line can be seen, the whole screen can be used for the display of the image within the display range while the visibility is kept. Accordingly, the whole screen can be effectively used to the utmost.

Besides, a recording medium recording a program code of software to realize the function of the embodiment may be supplied to the system or the apparatus. Besides, it is needless to say that the function is realized also when a computer (or a control device such as a CPU) of the system or the apparatus reads and executes the program code stored in the recording medium.

As the recording medium for supplying the program code in this case, for example, a flexible disk, a hard disk, an optical disk, a magneto-optical disk, a CD-ROM, a CD-R, a magnetic tape, a nonvolatile memory card, a ROM or the like can be used.

Besides, the computer executes the read program, so that the function of the embodiment is realized. In addition, an OS or the like running on the computer performs a part of or all of the actual process based on the instruction of the program code. A case where the function of the embodiment is realized by the process is also included.

Besides, in the present specification, the processing steps describing the time-series process include not only the process performed in time series along the described order, but also the process which is not processed in time-series but is performed in parallel or separately (for example, a parallel process or a process using an object).

The present disclosure is not limited to the foregoing respective embodiments, and it would be obvious that various modified examples and application examples can be made without departing from the gist of claims.

The present disclosure contains subject matter related to that disclosed in Japanese Priority Patent Application JP 2011-014157 filed in the Japan Patent Office on Jan. 26, 2011, the entire content of which is hereby incorporated by reference.

What is claimed is:

1. An image processing apparatus comprising:
an operation part that specifies, for an input image of an inputted video signal, a display range of the input image to be displayed on a display part according to a user operation; and
an image processing part that extracts an image within the display range from the input image when it is detected that the display range specified by the operation signal reaches an edge of four sides of the input image, and performs a process of drawing a line along an edge of a screen of the display part correspondingly to a direction in which the display range reaches the edge of the four sides of the input image.

2. The image processing apparatus according to claim 1, wherein the image processing part includes:
a control part that determines whether the display range specified by the operation part reaches an edge of the four sides of the input image; and
a video signal process part that generates an output video signal of the image within the display range extracted from the input image when the control part determines that the display range reaches an edge of the four sides of the input image, and superimposes, on the output video signal, a signal for drawing the line along the edge of the screen of the display part correspondingly to the direction in which the display range reaches the edge of the four sides of the input image.

3. The image processing apparatus according to claim 2, wherein
the control part calculates a position of the display range of the input image and an enlargement ratio of the input image to the screen of the display part based on the display range specified by the operation part, and
the video signal processing part generates the output video signal based on the position of the display range and the enlargement ratio calculated by the control part.

4. The image processing apparatus according to claim 3, wherein when the display range reaches an edge of the four sides of the input image, the video signal processing part generates the signal for drawing the line along the edge of the screen of the display part correspondingly to the direction in which the display range reaches the edge of the four sides of the input image, and generates the output video signal to shift the extracted image by a thickness of the line drawn along the edge of the screen of the display part and to display the image on the screen.

5. The image processing apparatus according to claim 3, wherein when the display range reaches an edge of the four sides of the input image, during continuation of the user operation, the video signal processing part generates the signal for drawing the line along the edge of the screen of the display part correspondingly to the direction in which the display range reaches the edge of the four sides of the input image.

6. The image processing apparatus according to claim 3, wherein when the display range reaches an edge of the four sides of the input image, the video signal processing part generates a signal for drawing a line blinking at regular time intervals along the edge of the screen of the display part correspondingly to the direction in which the display range reaches the edge of the four sides.

7. An image processing method comprising:
generating, by an operation part provided in an image processing apparatus, an operation signal that specifies, for an input image of an inputted video signal, a display range of the input image to be displayed on a display part according to a user operation; and
extracting, by an image processing part provided in the image processing apparatus, an image within the display range from the input image when it is detected that the display range specified by the operation signal reaches an edge of four sides of the input image, and drawing a line along an edge of the extracted image correspondingly to a direction in which the display range reaches the edge of the four sides of the input image.
